(19) United States
(12) Patent Application Publication
(10) Pub. No.: US 2007/0218321 A1
(43) Pub. Date: Sep. 20, 2007

(54) Lithium secondary battery featuring electrolyte solution circulation

(76) Inventor: Robert Neville O'Brien, Victoria (CA)

Correspondence Address: R. N. O'Brien, 2614 Queenswood Dr., Victoria, BC, V8N 1X5, CA

(21) Appl. No.: 11/374,600

(22) Filed: Mar. 14, 2006

(51) Int. Cl. H01M 2/38; H01M 10/50

(52) U.S. Cl. 429/10; 429/120; 429/81; 429/51

(57) ABSTRACT

It is suggested to make a lithium secondary battery that has magnetized current collectors in its electrodes, and paramagnetic free radicals in its nonaqueous electrolyte solution, thereby procuring decreased internal resistance for this battery, compared to a similar one not utilizing techniques for magnetic field promoted stirring of the electrolyte solution.

### BACKGROUND OF THE INVENTION

1. Technical Field

This invention relates to magnetic phenomena and exploitation thereof to enhance performance of a lithium secondary battery. The battery may be conventional in most respects but must use a nonaqueous carbon-containing (“organic”) electrolyte solution that is liquid at ambient temperature, at least in regions of electrode/electrolyte interfaces. The liquid state is necessary because density-driven convection must be initiable and increasable, so that practice of the invention will well circulate the electrolyte solution, to an optimized extent dependent on interactions among the following: two different magnetic forces; conventionally present charged species of ions; and, specially included paramagnetic moieties.

The inventor's lexicography dictates a meaning for the term “paramagnetic moieties” that includes—in addition to simple ions of cobalt, chrome, manganese, gadolinium, dysprosium, etc.—also complex ions and moieties of so-called “coordination compounds”, so long as they are paramagnetic. The latter may be complexes in which coordinated lithium ion is sequestered, or (so to speak) “caged” or “entangled”, typically exemplifying chelation.

Resort to this invention is intended to procure relief from two recalcitrantly problematic underlying factors contributory to a “thermal runaway” problem known to cause damage to portable electronic devices powered by lithium batteries, eg., laptop computers and cell phones.

Lithium's high reactivity, and inferior electrolytic conductivity of organic nonaqueous electrolyte solutions, are those recalcitrant factors. One aspect of lithium reactivity concerns unwanted side reactions, and another is formation of passivation layers on lithium electrodes. Non-uniformity of the film has been identified as causing uneven conduction with local overheating, and also growth of dendrites that can internally short-circuit a battery. Added to these aspects is ohmic resistance heating, excessive when there is high current density in a poorly conducting electrolyte solution. In more than one way, the low (lower-than-water's) dielectric constant of organic solvents in lithium battery electrolyte solutions exascerbates the high internal resistance factor. Unwanted chemical associations that can impede ionic mobility are more likely in lower dielectric constant solutions. Means for exerting a useful extent of control over all the foregoing problematic aspects and factors can include a suitably arranged magnetic environment for battery operation.

2. Description of Related Art Older Teachings of MHD-Related Circulation

Vigorous stirring of liquid-state electrolyte solutions to ensure uniform dispersal of constituents, improve mass transport, and lower internal resistance, is an old idea for which various inventors have described various implementations exploiting magnetic phenomena. One old implementation uncovered by searching was found in U.S. Pat. No. 1,658,872 to YEAGER for ELECTROLYTIC APPARATUS (February, 1928). In it, electrolysis devices were explicitly addressed; but, since the recharging of secondary batteries is an instance of electrolysis, the YEAGER patent is pertinent.

The YEAGER patent taught “causing a magnetic field to traverse the electrolyte at right angles to the direction of the flow of current”, where “direction of the flow of current” apparently implies a generally linearly directed initial—perhaps nominal—path of moving ions. Retrospectively, such perpendicularity-focussed language is rightly interpreted as alluding to magnetohydrodynamic (MHD) deflection of charged particles in motion.

YEAGER unfortunately was a disclosure entirely devoid of concern with temperature-related problems, and it is well known that electrolyte solutions in industrial open-bath electroplating operations are often desirably maintained at high temperatures that would be disastrous for charging a battery in place within a powered device.

Likely the world's most frequently performed electrolysis goes on in cars, inside history's most successful type of secondary battery to date. The lead-acid battery is versatile enough for both low and high drain applications, and it survives non-ideal (too fast) rechargings, usually. One inventor's suggestion that its electrolyte solution and electrodes may be cooled by magnetohydrodynamic stirring was disclosed in U.S. Pat. No. 3,597,278 to VON BRIMER for ELECTROLYTIC CELL COMPRISING MEANS FOR CREATING A MAGNETIC FIELD WITHIN THE CELL (August, 1971). Disclosed additionally to the suggestion of cooling by circulation achieved magnetohydrodynamically was lowering of internal resistance both during discharge and chargings. The illustrated lead-acid battery, without modification to the standard electrolyte solution or to electrode (“plate”) compositions, was presented as exemplary of much wider application of the magnets-promoted circulation. It was said that “the invention” applied to “different types of cells”, without naming any of the others, however.

The lead-acid battery was not exemplary of the whole range of secondary batteries in 1971, nor exemplary of all today, nor will it ever shed features making it non-exemplary, without ceasing to be the lead-acid battery VON BRIMER modified.

The lead-acid battery has anions (sulfate) moving in opposite directions, toward cathodes as well as anodes. It forms the identical side-reaction compound (lead sulfate) at both cathodes and anodes during discharge. Diminished density of its electrolyte solution, also during discharge, occurs by making water at both positive and negative plates. These features peculiar to it contribute to the lead-acid battery's uniquely patterned natural convection, about which the VON BRIMER patent teaches nothing, as though it were only magnetic fields between magnets in spacing structure driving the desired circulation. Decades of study of the matter validate the present inventor's statement here that the chemical reactions at the lead-acid battery's plates are what so produce solution density changes as to cause electrolyte solution circulation in the first place, even absent magnets.

Teachings of MHD-stirring Enhanced by Paramagnetic Effect

The next two cited patents stand as a virtual separate branch of the related art since, unlike YEAGER and VON BRIMER, they do teach electrolyte solution modification, teaching it in concert, however, with two very different overall combinations featuring magnetized battery elements respectively arranged according to each of the patents. In both patents the solution modification was addition of “indifferent” paramagnetic ions. This was first taught by O'BRIEN ET AL., U.S. Pat. No. 5,051,157 for SPACER FOR AN ELECTROCHEMICAL APPARATUS (September, 1991).

Suitable “indifferent” solute selections could be, eg., ions of chrome or manganese, or (optionally) “stable, soluble free radicals”. Nothing was taught concerning whether particular variations of battery elements were desirable when there was to be inclusion of organically derived radicals as the paramagnetic additives used to increase stirring instead of paramagnetic transition metal ions or other inorganically derived paramagnetic materials (eg., rare earth metals later suggested). All electrolyte solutions of the examples were aqueous; consequently, water was the only inherently present ligand available for in-solution complexing (not explicitly mentioned). It was well known (ca. 1990-91) that manganous ions in aqueous solution occur as hexaaquo complexes, but this instance of mere hydration is safely regarded as without significant bearing on magnetic phenomena involved per O'BRIEN ET AL. This would not have been a safe assumption for non-aqueous organic electrolyte solutions, because of the above-alluded-to increased extent of associations formation attributed to use of low dielectric constant organic solvents.

Laboratory experiments wherein paramagnetic additives caused accelerated flows adjacent vertical electrode/electrolyte interfaces at opposite cell sides, between which unobstructed flow could occur, had been done with the poles of an electromagnet furnishing its field projected into the cell from outside it, This arrangement considerably differs from what was taught in the O'BRIEN ET AL. patent, but actually is more similar to how magnetic fields project in the next-cited patent.

One of the co-inventors for O'BRIEN ET AL., over the years, determined that an improved arrangement needed to be taught, and the result was U.S. Pat. No. 6,194,093 to O'BRIEN for MAGNETIZED CURRENT COLLECTORS COMBINED WITH MAGNETIC SHIELDING MEANS (February, 2001).

Again proposed was the paramagnetic solute addition method of increasing stirring, but in a new combination locating stronger regions of magnetic field right in the vicinity of porous electrode structure—clearly differentiating the O'BRIEN arrangement from that of O'BRIEN ET AL. Common in the backgrounds to both was seminal academic journal article co-authored by R. N. O'Brien and K. S. V. Santhanam, reporting their discovery of interaction between a “paramagnetic effect” and a “magnetohydrodynamic effect”.

Three Key Journal Publications

The seminal article was: O'Brien et al., “Electrochemical Hydrodynamics in a Magnetic Field with Laser Interferometry—Influence of Paramagnetic Ions”, J. Appl. Electrochem., 20, 1990, pp. 427-437. Better understanding of interaction between the “paramagnetic effect” and “magnetohydrodynamic effect” came later, with more experiments leading to publication of O'Brien et al., “Magnetic field assisted convection in an electrolyte of nonuniform magnetic susceptibility”, J. Appl. Electrochem., 27, 1997, pp. 573-578. An interpretation arose that initially electromigration-driven accumulation of a non-discharging (“indifferent”) paramagnetic cation species, eg., manganous ion, in the diffusion layer at a horizontal cathode located above and parallel with a horizontal anode resulted in a localized solution density increase, thereby initiating gravity-driven convection where it would not normally be expected (Cathode-over-Anode cell). Notwithstanding the cationic character of manganous ion, convective force was several times more influential on direction of motion than electrostatic attraction, hence explaining “convective feeding of manganous ion back to the anode area until a quasi-equilibrium in Mn²+ ions is set up.” (bottom of p. 575, top of p. 576, J. Appl. Electrochem., 27, 1997).

Further interpretation goes on to ascribe rotation of solution (where no such rotation would usually be expected) to differential repulsion/attraction respecting the non-uniform magnetic field extending across unobstructed space between anode and cathode, parallel with their horizontal faces. It would be too complicated to here discuss extensively how findings of this second O'Brien/Santhanam publication combine with those of the first to elucidate, specifically, the interaction between paramagnetic and magnetohydrodynamic effects. The fact that the findings from the two publications did combine to advance the art has been confirmed by another research group which relatively recently acknowledged the two publications' significance, citing them in course of reporting that “electrochemical currents can be controlled and enhanced by the interaction of molecular dipoles with an external magnetic field”, p. 13468, Ragsdale et al., J. Am. Chem. Soc., Vol. 120, No. 51 (1998).

Making the Ragsdale et al. paper of great relevance to the present invention, concerned with a novel magnetically enhanced lithium secondary battery, is that the experimental cell to which the University of Utah researchers applied a nonuniform magnetic field, procuring mass transport-increasing stirring thereby, used a nonaqueous electrolyte solution. They therefore answered in the affirmative an important preliminary basic question on which Professors O'Brien and Santhanam had not acquired any information, namely: whether or not magnetic field assisted convection promoted by use of paramagnetic circulating species is feasible in a nonaqueous electrolyte solution. The art today knows that it is, thanks to Ragsdale et al., who accorded recognition to Professors O'Brien and Santhanam for priority of having suggested that electrochemical cells may be made to exhibit magnetic field controlled transport of paramagnetic liquids.

The nonaqueous electrolyte solution used by Ragsdale et al. for experiments reported in their paper, “ELECTROCHEMICALLY GENERATED MAGNETIC FORCES. ENHANCED TRANSPORT OF A REDOX SPECIES IN LARGE, NONUNIFORM MAGNETIC FIELDS” (citation above), contained nitrobenzene in acetonitrile with tetra(n-butyl)-ammonium hexafluorophosphate and methanol. Unfortunately, this is not a promising lithium battery electrolyte solution in connection with which to practice the present invention, because lithium itself has long been known to initiate or catalyze polymerization of acetonitrile, and polymerization of the solution would here (for the present invention) be undesirable. The presently high state of the art respecting polymerization in association with lithium batteries means, however, that there exists abundant information enabling artisans to avoid polymerizations as well as enact them, depending on what is wanted. When solution stirring is wanted, of course, polymerization is not. Since the present invention is meant to be capable of using organic free radicals (for exploiting their paramagnetism) in a lithium battery electrolyte solution that must be liquid-state in order to be stirred, the artisans will logically want assurance the radicals will not initiate polymerization.

Polymerizations and Coordinations

U.S. Pat. No. 6,482,545 to SKOTHEIM ET AL. for MULTIFUNCTIONAL REACTIVE MONOMERS FOR SAFETY PROTECTION OF NONAQUEOUS ELECTROCHEMICAL CELLS (November, 2002) taught utilization of free radicals in a lithium battery to initiate, when intended to do so, a conductivity-destroying polymerization of specially included multi-functional monomeric solution constituents, the object being to totally shut down current output to prevent a thermally running-away lithium battery from damaging a device it powers. Such initiation of polymerization by included free radicals teaches away from the present invention.

Not only unwanted polymerizations, but also some conceivable complex ion formations in solution, and other modes of in-solution chemical coordinations, can be detrimental to batteries intended to maintain fluent electrolyte solutions, largely because of depressing preferably high ion mobilities which normally are considered important to maintaining optimum electrolyte solution conductivity. Nevertheless, some inventors have addressed certain problems with rechargeable lithium batteries, especially of an “intercalation electrodes” lithium-ion type, by proposing measures to positively ensure that specific chemical coordinations, eg., sequestrations and/or chelations, will be present in the solutions concerned. Ligand field theory is the backdrop to this area, and one basic idea in this line of art is that sequestering the highly reactive lithium ions can keep them from provoking unwanted side reactions, especially in the vicinity of the electrode/electrolyte interface. Some detrimental reactivity of lithium is expected even for batteries on stand, neither discharging or being recharged. Special storage conditions, eg., in refrigeration chambers, could obviate such problems but a more stable battery is better.

U.S. Pat. No. 6,689,513 to MORIGAKI ET AL. for LITHIUM SECONDARY BATTERY (February, 2004), taught inclusion of ligands chosen to coordinate with lithium ions more strongly than either the solvent or the electrolyte, but not so strongly as to impede ionic mobility. Crown ethers, lariat ethers, and other specified organic substances were named as suitable to enable retention of more than 80% battery capacity after storage in a charged state for ten days in an atmosphere of 70 C. A clear inference that the coordinated complexes of this patent could enhance response to magnetic fields, to promote electrolyte solution stirring, probably would not be drawn by artisans making ordinary design choices respecting non-inventive modifications of the MORIGAKI ET AL battery, which needs no convection.

Researchers at Queen's University in Kingston, Canada, taught quite a few years ago how to produce “stable paramagnetic alkali radical cationic triple ions” in U.S. Pat. No. 4,201,638 to WAN ET AL. for TRIPLE IONS OF 1,2- AND 1,4-DICARBONYL COMPOUNDS AND. ANALOGS THEREOF CONTAINING NITROGEN AND CONTAINING TWO STRATEGIC OXYGEN OR NITROGEN GROUPS AND PROCESS FOR PRODUCING SAME” (May, 1980). This patent did not explicitly include battery-making among the arts which might find their then-new paramagnetic complexes useful, and polymerization initiation was the chief industrial use suggested. Significantly, however, tetrahydrofuran has long been known in the art as a candidate solvent for use in lithium battery electrolyte solutions, and it was tetrahydrofuran hosting one of the observed polymerizations in WAN ET AL. experiments. This specific polymerization, as all others, is undesirable for the present battery.

Philip P. Power has identified several kinds of radicals and complexes therewith, including some containing lithium, in “PERSISTENT AND STABLE RADICALS OF THE HEAVIER MAIN GROUP ELEMENTS AND RELATED SPECIES”, Chem. Rev., 2003, v. 103, 789. This article is relevant for reason of exemplifying the high state of art today in coordination chemistry, particularly with regard to customized designing of a wide variety of paramagnetic chemical complexes for whatever purpose needed. In connection with discussing triaryl boron radicals, Dr. Power includes mention of—and a schematic drawn representation of—lithium that is coordinated within a “cage”, the structure having been produced by known art utilizing addition of 12-crown-4 ether to solutions of LiBMes₃ in tetrahydrofuran. (The abbreviation “Mes” refers to 2,4,6-triphenylether.) Two comments with which Dr. Power closes this reference warrant quoting: “A feature of the recent radical work is that many of the radicals were generated fortuitously en route to other objectives.”—and—“The future will see a greater focus on designed stable radicals.”

Non-Stirring Magnetically Enhanced Batteries

Some related art references have proposed including magnetic components in batteries without necessarily confirming procurement of magnetic field assisted stirring of liquid-state electrolyte solution.

A magnetized current collector was proposed for holding ferromagnetic anode-making fragments together, by TAKAHASHI ET AL., whose ELECTRODE FOR ALKALINE STORAGE BATTERY AND METHOD FOR MANUFACTURE THEREOF obtained U.S. Pat. No. 4,000,004 (December, 1976). Unlike what YEAGER and VON BRIMER had taught, TAKAHASHI ET AL taught nothing about magnetic field effects on motion of a liquid electrolyte solution. A valid point raised concerning magnetization of that part of an electrode which serves for current collection was that this “does not entail a disadvantage that the iron-electrode has an increased weight or volume compared with the conventional countertype.”

U.S. Pat. No. 5,728,482 to KAWAKAMI ET AL. for SECONDARY BATTERY AND METHOD FOR MAKING THE SAME (March, 1998) affords a second example of utilizing a magnetic field in a battery for a rationale not concerned with liquid solution stirring. This battery can be either a zinc secondary battery or a lithium secondary battery, their modes of operation respecting the inventive concept presumably being identical even though one uses an aqueous solution that the other cannot. The Lorentz force is mentioned only in terms of “disturbing the electric field”, taught as effective to counteract uneven electrodeposition during chargings, thereby preventing dendrites. Liquid electrolyte solution was held inferior to gelled electrolytes (preferred). The provision of magnetic fields by incorporation of magnetic particles in electrode structure undesirably adds weight and occupies volume.

More recently published (Dec. 18, 2003) U.S. Patent Appl. Series Code 10, Serial No. 356723, by LEDDY ET AL., for METHODS FOR FORMING MAGNETICALLY MODIFIED ELECTRODES AND ARTICLES PRODUCED THEREBY, and, U.S. Pat. No. 6,890,670 to LEDDY ET AL. for MAGNETICALLY MODIFIED ELECTRODES AND METHODS OF MAKING AND USING THE SAME (May, 2005), agree substantially with doing what KAWAKAMI ET AL. had done a few years earlier. That was one of several options. A useful alternative to the embedded magnetic particles approach is also described by LEDDY ET AL.: to build up conventional electroactive electrode-forming materials on a rod, foil, sheet, mesh, or screen made of conductive magnetic material. This method agrees substantially with what TAKAHASHI ET AL had done several years earlier and what O'BRIEN had also done before LEDDY ET AL.

On, for example, nickel screen—one of many substrates able to be magnetized within an electrode, and which is recognizably a magnetized current collector, according to LEDDY ET AL. there may be coated anode-constituting materials of wide variety, including mention of lithium hydroxides and lithium carbonates. The published patent application's teachings afford a third example of exploiting magnetic field effects in batteries without averting to a rationale concerned with liquid-state electrolyte solution circulation.

A point in common among TAKAHASHI ET AL., KAWAKAMI ET AL., and LEDDY ET AL. is that nothing is taught about modifying liquid-state electrolyte solution to stir it better under magnetic field influence.

Background Conclusion

Risk of unintended liganding must be borne in mind when choosing paramagnetic additives to practice the present invention.

As alluded to already further above, ligand field theory must be consulted as providing a vital element in the new direction to which the present inventor now points, for using special paramagnetic additives in nonaqueous lithium battery electrolyte solutions. The now-old suggestion in O'BRIEN ET AL. (U.S. Pat. No. 5,051,157) to add ions like those of manganese and chrome to otherwise unchanged typical aqueous electrolyte solutions of magnetic field-subjected cells had only the water of hydration to contend with as a “ligand”, but in organic solvent-based nonaqueous electrolyte solutions for lithium secondary batteries the suggestion takes on greater complication, largely because of increased risks of unwanted polymerizations and coordinations that could hinder ionic mobilities and thereby negate purposes of the present invention.

### BRIEF SUMMARY OF THE INVENTION

The present invention's main object is to eliminate the well recognized thermal runaway problem in lithium batteries, by use of a special arrangement of two different magnetic forces interactive with usually included charged species and specially included paramagnetic moieties, which may be complex ions, lithium chelating agents, or of a “coordinated compound” nature, in an organic solvent-based electrolyte solution that is fluent (liquid-state) at least at electrode/electrolyte interfaces, at ambient temperature, in a new lithium secondary battery preferably having copper plated and/or aluminum plated face-poled magnetized current collectors in its electrodes.

The copper or aluminum platings are to cover and isolate permanent magnet material that will thereby never be in contact with electroactive materials participant in electrochemical processes of the battery.

Selection of the specially included paramagnetic entities must be done with a view to avoiding initiation by radicals of polymerization of any otherwise polymerizable organic chemical in the electrolyte solution.

Any coordination-type bonding between lithium and another species in solution must not be so strongly coordinated as to impede ionic mobility to an extent causing lowered battery capacity.

Choice of electrode configurations is not critical so long as any two nearest N and S magnetic poles of current collectors in adjacent electrodes face one another across a region within which flow of liquid electrolyte solution occurs.

Corollary objects of the invention including preserving as many as possible of the already known practical advantages associated with utilizing magnetic field promoted convection techniques in place of mechanical stirring of electrolyte solutions. As the older patents in this area have pointed out, eg., in the YEAGER and VON BRIMER patents cited above, there are specific disadvantages associated with mechanical stirring that suitable implementations of bona fide magnetic field promoted convection techniques avoid. A mechanical stirring implement placed in the solution to be stirred may be a source of contaminants, YEAGER pointed out. The present invention causes no such contamination.

Conventional mechanical pumps for stirring within comparatively small batteries cannot practicably be as small as desired, VON BRIMER pointed out. The space-occupying disadvantage of pumps is especially exascerbated in lithium batteries, for the following reason. Compared to zinc as a more traditional battery metal, lithium, with its density of 0.534 g/cm³, leads to an almost three times higher equivalent volume of 12.95 cm³/equivalent (stored electrochemical energy equivalency), since zinc is 4.518 cm³/equivalent, zinc providing much more stored energy per unit volume of metal. The electrochemical energy storage advantage of higher power density on a weight basis using lithium metal permits less heavy but not smaller cells. For a zinc electrode and a lithium electrode scaled to store equal amounts of electrochemical energy, the lithium electrode must be larger, thereby exascerbating the situation of internal battery space being at a premium. Moreover, an almost universally applied technique directed to compensating for relatively low electrolytic conductivity of typical lithium battery non-aqueous electrolyte solutions is to place anodes and cathodes as closely together as possible, leaving minimal thickness there between for occupation by the electrolyte solution.

Those factors which exascerbate the cramped space situation in lithium batteries make a substitution of magnetic field promoted convection in place of mechanical stirring far more important and desirable than usual.

Lithium battery design for implementation of magnetic field promoted convection techniques requires addressing new problems and so cannot factually and logically be as simple a matter as transferring over known techniques applied with success previously to aqueous electrolyte solutions of batteries of other types. Objects of the present invention therefore include adaptations making allowance for major differences between “aprotic” or “inert” organic solvents and water.

Water is an amphiprotic solvent that undergoes autoprotolysis, which is negligible if not totally absent for aprotic organic solvents of typical nonaqueous electrolyte solutions for lithium batteries. Also, water hydrates metal ions in solution, acting as a ligand in formation of “aquo” complexes that organic solvents do not form, and, compared to organic ligands, autoprotolyzed water of aquo complexes is innocuous respecting affecting paramagnetism of hydrated metal ions, whereas, on the contrary, carbon-containing ligands from organic solvents, CN for example, pose a significant risk of suppressing paramagnetism of the coordinated ion or molecule. The paramagnetism suppressing mechanism is usually well explained in university-level chemistry textbooks, in connection with ligand field theory.

Moreover, lower (than in aqueous solution) ionic mobilities result from the more pronounced associations and coordinated compound formations occurring in most organic solvent-based solutions, largely because of low dielectric constants.

To conceptualize clearly the technical objects of the present invention, it was vital to take into consideration marked differences between non-aqueous electrolyte solutions in lithium batteries, and aqueous electrolyte solutions like that of the lead-acid battery which Professors O'Brien and Santhanam magnetically enhanced fifteen years ago.

The above cited O'BRIEN ET AL and O'BRIEN patents suggested free radicals as useful paramagnetic additives to battery electrolyte solutions presumed to be aqueous, so that there clearly was no prospect of the free radicals initiating polymerization of water. Years later now, in an entirely different chemical setting, recent developments have shown (SKOTHEIM ET AL.) that including free radicals in organic solvent-based nonaqueous electrolyte solutions for lithium batteries affords initiation of a polymerization reaction as a safety measure; but that must be avoided in order to practice the present invention. Thus, another object of the present invention is therefore to provide heretofore absent guidance to assure workers in the art that unwanted polymerization will not incidentally occur as a result of putting free radicals into a lithium battery's electrolyte solution in order to stir it vigorously by magnetic field promoted convection. Without guidance, unwanted polymerization would likely have been construed as a stumbling block obstructing extension of magnetic field promoted convection from aqueous solution contexts to the different nonaqueous solution context.

Another stumbling block, removal of which is an object of the invention, would have been construed as present because the workers in the art appreciate the greater likelihood of paramagnetism suppression associated with water-free complexing and coordination compound forming in organic nonaqueous solutions. In details below, such suppression is ruled out.

### BRIEF DESCRIPTION OF THE DRAWINGS

FIG. 1, labeled “RELATED ART”, is a schematic illustration of an invention disclosed in U.S. Pat. No. 5,051,157 to O'BRIEN ET AL. (September, 1991).

FIG. 2, labeled “RELATED ART” reproduces a figure (FIG. 8) from J. Appl. Electrochem. (1990), v. 20, pp. 427-437 at 431, Professors O'Brien and Santhanam, co-authors.

FIG. 3 illustrates a lithium secondary battery, during charging, that is a substantially redesigned modification of what FIGS. 1 and 2 and other related art disclosures previously suggested.

FIG. 4 illustrates the battery of FIG. 3 during discharge

### DETAILED DESCRIPTION OF THE INVENTION

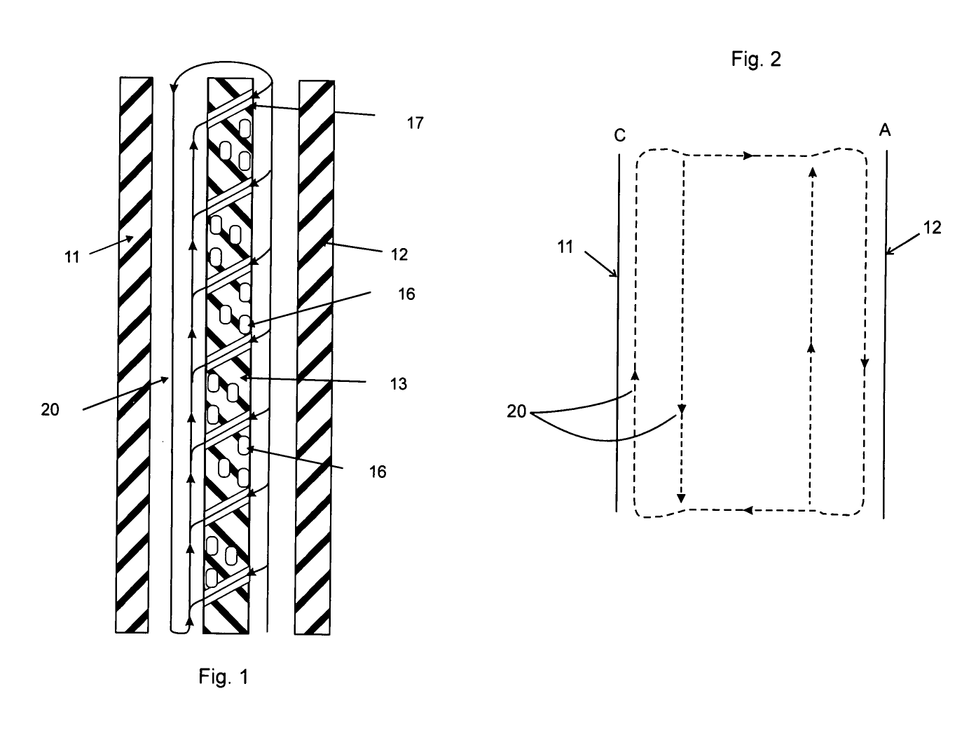

With reference to “RELATED ART” FIG. 1, it is thought that, out of all patent-disclosed batteries suggested to be operated with permanent magnets used specifically to procure predetermined patterns of liquid motion during a current-producing process, this figure of illustration, which was FIG. 2 in the abovecited O'BRIEN ET AL patent, is the only known instance of graphically depicting a magnetic field promoted “convective stream”, represented in the figure by the long arrow-headed line 20, which commences at the lowermost right side, just left of the foot of anode 12, and which thence rises upwardly next to and parallel with anode 12, before turning left to descend next to and parallel with cathode 11 but as previously noted, para. 10 page 4 this is not the correct flow path.

Rarity and significance of showing a magnetic field promoted convective streams closely similar to that herewith proposed justifies quoting the brief passage describing FIG. 2 of the O'BRIEN ET AL patent (here RELATED ART FIG. 1): “The convective stream in the electrolyte as seen in FIG. 2 shows (by arrows 20) that the electrolyte travels downwardly adjacent the cathode 11, then upwardly adjacent the spacer 13, and then upwardly adjacent the anode 12. The vortex stream of the electrolyte is seen to pass through the slits 17 in the spacer 13 to provide an increase of 5% to 10% in the flow over that where the slits are not provided.”

The alternative description herewith supplied preceding the immediately above paragraph (with the quotation) systematically started from the unheaded foot of convective stream arrow 20 where it commenced. Both descriptions are consistent with the figure; however, the one here supplied has the merit of disregarding presence of spacer 13.

The here-disregarded spacer 13 was said in the patent for which it was an essential element that its use accounted for “an increase of 5% to 10% in the flow”. To the left and upwardly on the same page in the O'BRIEN ET AL. patent, a paragraph explained that enhanced stirring resulted from adding suitable paramagnetic solute material to the already magnetically influenced electrolyte solution. That paragraph concluded with the following statement: “Reductions in small cells of up to about 40% in impressed voltage to produce a given current density in 0.6 T field have been produced.” An artisan apprised of these items of information might well think that the 5% to 10% flow increase attributed to spacer 13, presumably compared to that much less flow without the spacer, was a major factor in obtaining the 40% impressed voltage reduction. The case really is not so simple, however.

The origin of the 40% impressed voltage decrease data, traces to the background reference, the Journal of Applied Electrochemistry article, v. 20, (1990), concerned with influence of paramagnetic ions. The 40% figure occurs in page 430's first paragraph, which reported significant magnetic field effects found by following interferometric fringe shifts manifested during an electrolysis utilizing an aqueous solution that combined two different electrolytes dissolved in water, namely: 0.1 M ZnSO₄, and 0.1 M MnCl₂. The 40% impressed voltage reduction finding had nothing to do with the slitted spacer 13 shown here in RELATED ART FIG. 1, but did have to do with increased stirring obtained by the use of paramagnetic ions.

The circulatory direction of convective stream 20 in FIG. 1 here (and source FIG. 2 of O'BRIEN ET AL) is upward at an anode and downward at a cathode. This circulatory direction is the reverse of that shown in FIG. 8 in the O'Brien/Santhanam J. Appl. Electrochem. article, page 431.

FIG. 8 of that article is RELATED ART FIG. 2 here supplied, showing flow directions downward at an anode and upward at a cathode. The purpose of showing the two circulations for two different cells, where the directions of circulation are reversed, is to alert artisans to be cognizant that the related art figures do not justify a priori assumptions concerning which direction convection of a lithium cell's liquid electrolyte solution will take, relative to its cathode and its anode. Irrespective of whether any given cell is a galvanic cell with spontaneity of electrolytically linked separate half-reactions producing current for an external circuit, or else is an electrolysis cell needing DC electricity to cause reduction and oxidation, “anode” always means where oxidation occurs and electrons go into the external circuit, and cathode always means where reduction occurs and electrons come from the external circuit.

Thus, with reference to FIGS. 1 and 2, reversed circulatory directions of their respective convective streams cannot be accounted for merely by saying the latter depicts an electrolysis cell but the former depicts a discharging battery (lead-acid). What accounts for the different circulatory directions are details of differences in how density-driven free convection occurs in the particular cells concerned, owing to changes in concentration, hence densities, at the opposite electrodes.

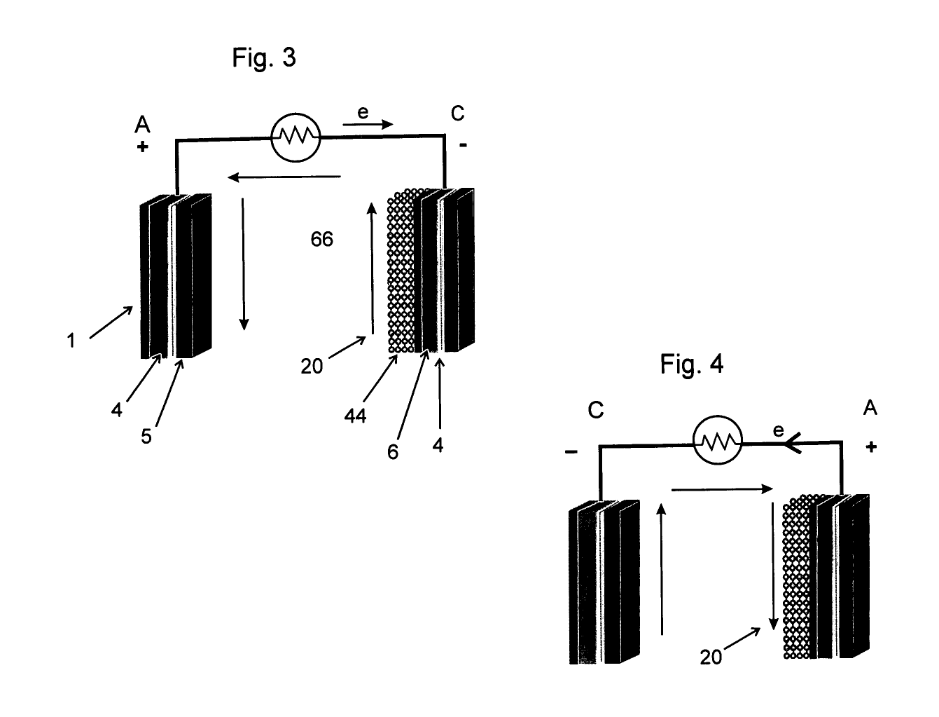

Without proceeding further into all complications raised by reversed circulations in related art cells, the point is: implementing the present invention, which puts magnetized current collectors and free radicals in a lithium battery to procure magnetic field promoted convections requires help provided by FIGS. 3 and 4, since information associated with RELATED ART FIGS. 1 and 2 does not pertain to this particular battery.

FIGS. 3 and 4 are simplified schematic representations that depict the same lithium secondary cell (rechargeable battery) twice, side-by-side beside itself and not in mirror image representation, but rather with left hand electrode 1 in FIG. 3 being the same left hand electrode 1 in FIG. 4, and with right hand electrode 3 in FIG. 3 being the same right hand electrode 3 in FIG. 4. Why “C” and “A”, indicating cathode and anode, switch sides in moving from looking at FIG. 3 to looking at FIG. 4 is explained by the fact that FIG. 3 illustrates the battery during charging, whereas FIG. 4 illustrates it during discharge.

The changed labeling with “C” and “A” reflects the fundamental fact that a secondary cell's cathode during charging will be the anode during discharging, and the anode during charging will be the cathode during discharging, simply because they are the sites of reversible oxidation/reduction half-cell reactions.

Density-driven free convection in liquid-state electrolyte 2 for the battery as shown in FIGS. 3 and 4 changes direction, as between during charging and discharging. This change is shown using arrow-headed line 20, which points clockwise in one figure and counterclockwise in the other. During discharging, the battery of FIG. 4 has reactant products of oxidation at its anode 3, and of reduction at its cathode 4, the products entering solution 2 adjacent each electrode, causing localized density differences. In FIG. 3, oxidation is of course also at the anode 3, and reduction at the cathode, as always. The anode for discharge is the electrode that is a cathode for charging, the cathode for discharge being the anode for charging, for the obvious reason that what is illustrated is a secondary cell.

An electrolyte solution, in accepting reactant products of an electrochemical reaction of the nature of an electrode process will typically undergo a density change, either an increase or else a decrease, in the vicinity of an active electrode, as was well studied and reported on by the Tobias group, many years ago at the University of California at Berkeley. Thus, when the density increases at one side of a two electrode cell, and decreases at the other, a circulatory pattern of density driven convection is expected. The direction of moving fluid will then, of course, be upward where the fluid's average density decreases, and downward where it increases. Tobias gave a formula to calculate this.

Inherently, assuming vertical plane parallel electrodes looked at in side elevation view, a resulting circulatory pattern is either clockwise or else counterclockwise depending on which side is where the density increases relative to density at the other side. The physical fact of density driven convection in fluent electrolyte solutions of active electrochemical cells is so well established that two-way inferences from detected evidence, of the following sort, are justified: if a circulatory flow pattern is detected by any suitable means, and there is no other apparent explanation for it, then the presence at opposite electrodes of density changes opposite in effect (increase at one, decrease at the other) may be inferred; and, if what evidence suggests in the first place is presence of the opposed density changes, then, even without direct detection of a circulatory flow, it may be inferred to be happening, absent any apparent reason for it not to happen. This last-mentioned second type of inference was what made the present inventor's academic investigations of cells set up as interferometers so valuable a tool for convection analysis of a type not requiring means for direct fluid flow measurement, which would not have been practicable anyway, in the case of the tiny cells studied.

The very low density of lithium could be a somewhat misleading factor in considerations concerned with direction of possible density driven convection in non-aqueous organic solvent-based electrolyte solutions. Artisans need to appreciate that virtually all lithium compounds except with boron are heavier than water, and that most lithium conveying electrolyte solutions, although not aqueous, are not significantly unlike water, though generally slightly lower, in their densities. From these facts it follows as a reasonable expectation by the present inventor that any utilizable (for density driven convection) form of lithium, other than bare unreacting ions, coming off the anode will likely increase the density of the electrolyte solution in that immediate region, thereby driving convection in the usual way so often found previously in the inventor's academic investigations of cell processes, both with and without magnetic field assisted convection.

Now referring to FIG. 3, the integral means for applying a magnetic field to the lithium secondary cell should be constituted by magnetized current collectors 22 located at sides of electrodes' main active material bodies 44 that are sides opposite to junction of other sides of bodies 44 with liquid-state organic solvent-based nonaqueous electrolyte solution 66. Collectors 22 are face-poled magnets so locating opposite poles, N and S, across from one another with both bodies 44 and solution 66 there between, as to ostensibly procure a substantially uniform magnetic field through the whole region between collectors 22. However, as the inventor and former colleague Santhanam previously discovered, and which has since then been publicly recognized and confirmed by the University of Utah group publications (Ragsdale et al. cited above), an induced non-uniform field is created because of local magnetic susceptibilities varying in the solution.

Although the above cited Journal of the American Chemistry Society article by Ragsdale et al. provides assurance that magnetic field assisted convection can occur in organic non-aqueous solutions, not just typical aqueous solutions, it was at one place pointed out that the particular experimental set-up for the article featured no excess of “supporting electrolyte” and that this resulted in an apparently anomalous finding of decreased electrolytic conductivity in solution adjacent an electrode, which clearly is a phenomenon not wanted here. Implementation of the present invention avoids the noted resistance-increasing phenomenon by not replicating the conditions of the University of Utah group's experiment, specifically by not using electrogenerated/electroconsumed redox-active species of paramagnetic solute as the convective flow velocity accelerator in solution 66 employed in concert with imposed magnetic fields of collectors 22 in the lithium battery contemplated. Such species must not be used in carrying out the present invention.

The thorny problems associated with handling the “stumbling blocks” discussed in the SUMMARY section above are to be addressed without the unwanted complication of redox shuttles in a battery, which would produce an internal energy leak. This matter was briefly dealt with in the O'BRIEN magnetized current collectors patent cited above.

Elucidation in greater detail of removing the two stumbling blocks is now in order, beginning with consideration of the sometimes proposed safety feature for lithium batteries (Skotheim et al.), of intentionally so preparing their electrolyte solutions that, if a predetermined internal temperature is reached, polymerization to raise resistance to the extent of shutting down the battery will occur.

U.S. Pat. No. 6,482,545 (November, 2002) to Skotheim et al. for “MULTIFUNCTIONAL REACTIVE MONOMERS FOR SAFETY PROTECTION OF NONAQUEOUS ELECTROCHEMICAL CELLS” lists suitable free radical polymerization initiators, and (inherently) the free radicals present change the magnetic properties of the electrolyte solution even when not in course of initiating polymerization.

Quoting from the Skotheim et al. patent, second paragraph under subheading “Polymerization Initiators”: “Examples of suitable free radical polymerization initiators include, but are not limited to, acyl peroxides, such as, for example, diacetyl peroxide, and dilaury peroxide; peresters, such as, for example, tert-butylperoxy pivalate, tert-butyl peroxy-2-ethylhexanoate; alkyl peroxides, such as, for example, dicyclohexyl peroxydicarbonate; and azo compounds, such as, for example, 2,2′-azobis(isobutyronitrile), 2,2′-azobis (2,4-dimethylvaleronitrile), 1,1 ′⁻azobis(cyanocyclohexane), and 2,2′-azobis(methylbutyrobnitrile).”

The foregoing exemplary radicals for polymerization initiation use are—for Skotheim et al. purposes—suitable when the multifunctional monomer to be polymerized at a predetermined temperature comprises “two or more unsaturated aliphatic reactive moieties per molecule”, and, because the proposed polymerization is to occur in situ within the non-aqueous electrolyte solution of the lithium cell concerned, the multifunctional monomer must be soluble in the solvent for the battery's electrolyte solution. So, the SKOTHEIM ET AL. recommendation is: “a solvent selected from the group consisting of: N-methyl acetamide, acetonitrile, organic carbonates, sulfolones, sulfones, N-alkyl pyrrolidones, dioxolanes, glymes, siloxanes and xylenes.”

Those who possess skill in both the arts of battery-making and polymerizing organic materials are capable of observing that non-aqueous electrolyte solutions of lithium batteries containing any of the known organic solvents suitable therefor possibly could have added thereto any free radicals listed by SKOTHEIM ET AL., without ensuing polymerization reaction, provided that the multifunctional monomer to serve as the polymerizable constituent were omitted.

However, the constantly expanding and already immense range of organic previously un-contemplated organic material polymerizations discovered to result from initiation by free radicals, whether planned or not, makes it important to adopt an additional and more proactive response to the problem of ruling out unwanted polymerizations. Refraining from carrying out the entirety of SKOTHEIM ET AL. teachings does not suffice.

Hence, guidance here supplied by the present inventor is to carry out routine “hot box”-type screening tests of all candidate prototypes of cells intended to carry out the present invention.

Such a test is most easily performed as an instance of destructive testing, as described in SKOTHEIM ET AL.: opening the test cell to see if its electrolyte solution has solidified or not. If this will have happened at a temperature at which continued operation of a stirred-electrolyte type cell would be practicable except for the tested-for polymerization, then the particular combination of organic solvent constituents and included free radicals is unworkable.

Removal of the first stumbling block to adding free radicals to a magnetically enhanced lithium battery's liquid-state non-aqueous electrolyte solution being accomplished, the second block, concerning diminished paramagnetic effect remains.

For inclusion in liquid-state organic solvent-based non-aqueous electrolyte solutions prepared for use in lithium batteries having electrodes containing magnetized current collectors, soluble and stable paramagnetic solutes that are not redox-active, particularly organically derived free radicals that are not redox-active, must be selected with a criterion not only to avoid procuring unwanted free radical initiation of polymerization of solution constituents, but also with the additional criterion of avoiding in-solution coordination compounds and complexes in which certain ligands significantly diminish “shown”, i.e., effective, paramagnetism of a hypothesized candidate (but rejected) solute that would, if chosen, manifest significantly diminished paramagnetism in the solution, compared to when considered in isolation. This means that tables listing magnetic susceptibility data for various substances are not entirely sufficient for guiding paramagnetic solute selection, since in-solution changes must be given careful attention.

Here in order is a brief explanation of what significantly differentiates the present teachings from earlier O'BRIEN suggestion to add selected paramagnetic solutes to typical aqueous solutions of the formerly proposed batteries having magnetized current collectors as means for procuring magnetic field assisted convection. Water is an amphiprotic solvent, not aprotic as are the organic solvents of today's typical electrolyte solutions for lithium batteries. Also, water in electrolyte solutions undergoes autoprotolysis. Further, water hydrates metal ions in solution, forming “aquo” complexes. For example: where, as in above-cited U.S. Pat. No. 5,051,157 to O'BRIEN ET AL, manganous ions were suggested as paramagnetic convective flow accelerators suitable to be used, it would have been appreciated by artisans of the field (chemists) that the Mn²+ cation in aqueous solution occurs as [Mn(H₂O)₆]²⁺, a “hexaaquo complex”.

The available evidence tracing back to the seminal 1990 article by Professors O'Brien and Santhanam (cited above), on enhanced stirring due to influence of paramagnetic ions on magnetic field assisted convection, implicitly means that the paramagnetic effect was not compromised by whatever extent of formation of manganous hexaaquo complexes may have occurred in the experimental conditions. The innocuous nature of water with respect to effective (“shown”) paramagnetism of the solute additive there used to enhance stirring is considered to have never been in doubt.

The three factors concerning water that were identified above (amphiprotism, autoprotolysis, hydration forming aquo complexes) are “innocuous” in the sense of not introducing any significant likelihood of suppressing effective paramagnetism. A different set of factors cannot help but be manifested when the change has been made from using water as the solvent, to instead using organic solvents that are aprotic rather than amphiprotic, that cannot autoprotolyze, and that form complexes in solution other than by hydration. The switch to water-free aprotic solvents is a fait accompli in the context of most practical contemporary lithium batteries, and implications of the switch include need for guidance how to adapt to it, in order to render viable the technique of using paramagnetic solutes to enhance magnetic field assisted convection in water-free lithium batteries having electrolyte solutions using a wide range of non-aqueous solvent components, such as all those types listed above in citing the patent of SKOTHEIM ET AL, and particularly (with some repetition): tetrahydrofuran; dioxolane; sulfolane; -butyrolactone; 1,2-dimethoxyethane; dimethyl formamide; methyl formate; ethylene carbonate; propylene carbonate; and mixtures of the same. These have been called “aprotic” and sometimes “inert” solvents, and they do not appreciably autoprotolyze.

It will be well within the existing level of skill in the art to prepare a fluent, liquid-state (at ambient temperature) electrolyte solution for the new lithium cell which will manifest enhanced convection to which both of the two magnetic forces known in this area of art are designed to contribute. These are: (first) the magnetohydrodynamic effect force; and, (second) the paramagnetic gradient effect force. Both have long been recognized, and have in recent years become easier to experimentally isolate from one another, such isolation, for the purpose of academic investigation, having been achieved in the abovecited work of Ragsdale et al. at the University of Utah. That work was also significant in that the organic solvent based electrolyte solution used was not highly dissimilar from the typical non-aqueous electrolyte solutions usable in ambient temperature lithium secondary cells.

Moreover, the Ragsdale et al. work supplements earlier teachings by O'Brien et al. and O'Brien, so that today it is considered also within the existing level of skill in the art for the artisans to ensure that carrying out the present invention in practice will use the two magnetic forces (magnetohydrodynamic and paramagnetic) in constructive concert with one another. The isolation of the one from the other, as done by Ragsdale et al., is actually more difficult and atypical of the usual situation wherein both forces are operative, but the proven technique of isolation was explained in clear terms to which it is implicit that it is already known how the two forces interact when both are allowed to be present.

That the present invention is designed to utilize both a magnetohydrodynamic and a paramagnetic effect will best be appreciated by making reference to FIGS. 3 and 4.

FIGS. 3 and 4 schematically illustrating the invention, are not intended to be “working drawings”, and certainly are not drawn to scale proportions, especially with respect to apparent distance between electrodes.

In the Winter 1995 edition of The Electrochemical Society Interface publication, on page 34, an article by S. Megahed and R. Scrosati, entitled “Rechargeable Nonaqueous Batteries”, there is a figure, FIG. 1, captioned as “Schematic illustration of the discharge process of a lithium rechargeable battery”. In general, the schematics of that figure are similar to FIG. 4 here, representing the discharging state, whereas FIG. 3 illustrates the reverse process, charging.

As is often done with schematic illustrations of battery processes, the Scrosati et al. figure indicates by directional arrows the general direction of flow of ions from one electrode to the other, giving the impression that actual flow is straight across, horizontally because the spaced-apart anode and cathode are represented as plane parallel vertical electrodes.

This convention of illustration (used, e.g., by Scrosati it al.) does not indicate actual patterns of density driven convective flow that by viscous drag among solution constituents transportions other than by mere electromigration. Much more often than not, the convection is expected to occur because electrolyte solution concentration, hence density, is differentially changed at opposite sides of the solution body. The anode releases the electroactive species into the solution, and the cathode receiving that species removes it from the solution with the earth's gravity field supply the motivation for natural convection and increasing the conductivity to give maximum current densities as measured by Tobias.

The convention of ion flow direction straight across from an anode to a cathode merely shows, in other words, a nominal general direction, and indeed, a direction which takes as given an assumption that diffusion and electromigration are the only causes of the motion of the electroactive species of ion. In contrast to the nominal direction-of-flow convention, here FIGS. 3 and 4 indicate predicted actual hydrodynamic flow patterns, shown by means of arrows 20, the arrow 20 in FIG. 3 trending clockwise for the charging case, and counterclockwise for the discharging case of FIG. 4.

It was already briefly mentioned above that the low density of lithium should not be assumed to entail that an electrolyte solution is lightened (reduced in average density) by receiving lithium ions, since the likelihood of virtually instantaneous in-solution compounding should be considered, and most lithium compounds will have a density greater than the average solution density without their addition.

Thus, particularly in the case here contemplated, wherein the most preferred “paramagnetic additive” solutes for the most preferred nonaqueous electrolyte solution should be such as to form with released lithium ions a paramagnetic complex temporarily coordinating, chelating, sequestering, or—in a manner of speaking—“entangling” the lithium ions according to the requirements of electrical neutrality. The expected complex ion moieties in the solution will tend to increase its average density in the vicinity of lithium release (anode), and decrease the density where the cathode process de-coordinates the temporary lithium-entangling complexes and withdraws the lithium from the solution. This explains why the trend of arrow 20 in FIGS. 3 and 4 is shown as it is, in these figures, the reversal of the trend being because the electrode that is the anode during discharge is the cathode during charging, as shown by changed positions of “C” and “A” respecting the two figures.

The left-hand electrodes 1 of both FIGS. 3 and 4 are the same reversible electrode, and so too are the right hand electrodes 2. Details of material construction of electrodes 1 and 2 are intended to be whatever is in substantial agreement with presently available practice respecting conventional construction of electrodes for lithium secondary batteries, with the single exception that face-poled magnets, facing poles N and S across the width of the body of non-aqueous electrolyte solution 3, are to be the electrodes' current collectors 4, which may be made of any suitable material previously proposed for magnetized current collectors, per the cited related art instances, and here providing, for the preferred embodiment, that a copper plating 5 is on the left hand (designated “negative”) current collector 4, while an aluminum plating 6 is on the righthand (designated “positive”) current collector 4.

The illustrated plating practice is recommended as effective and inexpensive but may be altered judiciously by those having skill in the art, without affecting the essential character of the present invention, which is compatible with a wide variety of other platings, eg., much more expensive platings using silver, gold, or platinum. Nickel also is known (see cited TAKAHASHI ET AL. patent) to be useful as magnetized current collector plating material. The basic reason for platings 5 and 6 on current collectors 4 is to prevent corrosion of the magnetic material thereof; eg., oxidation of neodymium-iron-boron magnets is known to cause deterioration of magnetic properties.

As electrodes may be conventional except for magnetic current collectors, so too may existing types of organic solvents and various nonaqueous electrolyte solution constituents be used, so long as not incompatible with paramagnetic additive 33 present in solution 3.

Reliance may be placed on related art teachings, e.g., by MORIGAKI ET AL and others, for assurance that formation of complexes, coordination compounds, and sequestering with lithium ions does not impede the fundamental electrochemical processes of lithium cells. What those teachings had not been evolved in contemplation of is enhancement of density driven convection by magnetic forces, but magnetic field promoted stirring is not expected to render use of suitable liganding agents in solution any more problematic than usual.

Bearing in mind the brief review above of current knowledge regarding free radical complexes that are inherently paramagnetic, the range from which to select suitable candidates for enhancement of the convection of a lithium ions-transporting electrolyte solution is truly immense. However, owing to an advanced state of technology for testing magnetic/paramagnetic properties of substances in solution, using NMR, ESR, and other equipment, including permeammeters and magnetic balances, screening for suitable additives call for no more than routine experimentation that is not undue.

Considering that so much pre-existing technology can be drawn on to carry out the invention as described, plausibly the most important new teaching associated with this advancement of magnetoelectrolytic art is that exclusion of free radicals-polymerizable materials from the electrolyte solution 3 of any embodiment of this invention is essential. What is here needed are free radicals for paramagnetic effect enhancement of magnetohydrodynamic enhancement of density driven convective enhancement of transport of ions between electrodes, but unwanted polymerization would render convection impossible, hence the magnetic enhancement thereof a meaningless non-starter

Preparing an electrolyte solution 3 that can preserve a low enough viscosity during all expected conditions of cell operation to ensure practicability of the magnetic field promoted convection specified is essential to the invention. Fortunately again, existing tool for ascertaining electrolytic solution convection, even in very small cells, have become well known, in part because of the present inventor's own long-time contributions in the area of setting up test cells as interferometers so that the optical changes, interpreted as density changes, inferred as causative of convection, are detectable by anyone of skill in the art who chooses to follow in the readily available path of using the technological tools needed, but already available, for doing the routine engineering design aspect of putting the present invention into embodied practice.

Practical battery casing designs, details of terminals, actual scaling and proportions of elements, and so forth, are best left to the battery-making engineers. Once they will have grasped the importance of recognizing viability of removing the above former obstacles to treating non-aqueous solutions essentially the same way as aqueous solutions, the obstacles will prove easy for them to remove. The artisans will have to pay careful attention to: Keeping anything out of solution 3 that could be polymerized (a la SKOTHEIM ET AL.) by paramagnetic additive radicals, and avoiding co-ordinations with lithium that are too strong to be broken by the appropriate electrode process. In general, it is believed that the state of the art is instantly ready to carry out the present invention, be it only conveyed to the artisans what it is.

In the recent past the adaptation of nuclear magnetic resonance to the detection of disease in humans has had results enhanced by using chelated gadolinium compounds. These compound and their structures appear in the paper of F. Li and H. Sun in Physical Organometallic Volume 4, Fluxional Organometallic and Coordination Compounds, Page 202. These authors give the structures of Gadolinium chelate structures used to enhance the results which depend on being soluble in human plasma and cell fluids which do not contain large amounts of water. It is clear that they are designed to be soluble in mainly organic solvents that are polar in nature. Since, to be of use as solvent of an electrolytic cell, the solvent must be polar to cause sufficient dissociation to produce mobile ions. The most promising, for solubility in such organic solvents as the cyclic carbonates, of these chelate compounds of gadolinium are octadentate. Two examples of the chelation agents are diethyltriamine-N,N,N′,N″,N′″-pentaacetate, and 1,4,7,10-tetraazacyclododecane-1,4,7,10-tetraacetate, with this last the most soluble in the organic solvents currently used in Li ion batteries.

What is claimed as new is:

1. In a lithium secondary battery comprising a positive electrode, a negative electrode, and a nonaqueous electrolyte solution that contains no constituent polymerizable by initation of polymerization by free radicals present, the improvement consisting of
inclusion, in the structures of each of said electrodes, a face-poled magnetized current collector, and
inclusion, in said nonaqueous electrolyte solution, of a sufficient amount of free radicals to enable utilization of the inherent paramagnetic property of said free radicals for enhancing a magnetic field promoted stirring effect,
whereby a decrease in internal battery resistance can be procured, owing to said magnetic field promoted stirring effect.

2. In a lithium secondary battery as in claim 1, free radicals selected specifically for the purpose of coordinating temporarily, in said electrolyte solution, with lithium ions or in association with the chelated Gadolinium ions which may be added to the free radical solution or used as separate para-magnetic entities.
